(19) United States
(12) Patent Application Publication
(10) Pub. No.: US 2003/0077137 A1
(43) Pub. Date: Apr. 24, 2003

(54) Drill

(75) Inventor: Gunter Horst Rohm, Sontheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: ROHM GmbH

(21) Appl. No.: 10/016,889

(22) Filed: Dec. 14, 2001

(30) Foreign Application Priority Data
Oct. 23, 2001 (DE) 10151582.0

(51) Int. Cl. B23B 45/00

(52) U.S. Cl. 408/239 R

(57) ABSTRACT

A drill has a drive spindle centered on and rotatable about a spindle axis and formed centered on the axis with an axially forwardly open socket of noncircular section and with at least one radially throughgoing passage open radially inward into the socket. A locking element is radially displaceable in the passage between an inner position projecting radially inward into the socket and an outer position clear of the socket and projecting radially outward from the spindle. A collar is formed with an inner surface closely juxtaposed with an outside surface of the spindle and with a radially inwardly open recess. The collar is axially displaceable on the spindle between a locked position with its inner surface pressing the element into the inner position and an unlocked position with its recess level with the element and the element movable into the outer position engaged in the collar recess.

### FIELD OF THE INVENTION

The present invention relates to a drill. More particularly this invention concerns a drill for a quick-release chuck.

### BACKGROUND OF THE INVENTION

A standard drill chuck comprises a chuck body centered on and rotatable about an axis and formed with a plurality of mangled guides spaced about the axis and each holding a respective jaw. Rear edges of the jaws have rows of teeth meshing with an internal screwthread of a tightening sleeve that can be rotated in one direction to advance the jaws axially and bring them together radially so as to grip a tool and in the opposite direction to separate the jaws and release the tool. Means may be provided to lock the tightening sleeve to prevent unwanted loosening of the chuck.

As a rule the chuck body is formed with an axially rearwardly open threaded bore into which fits an externally threaded spindle of a drive unit. The two parts are screwed together under substantial torque so that the chuck stays solidly mounted even under the considerable angular forces that it is subjected to in normal use. Frequently a radial set screw is fitted to the body and engages the spindle to angularly lock the parts together even more solidly.

Thus it is in theory possible to remove and replace the chuck, but this operation often is extremely difficult since over time the chuck body and drill spindle become frozen together. Thus changing a standard chuck as describe above with, for instance, a collet chuck or some sort of special-duty chuck is not practical, and normally not something easily carried out in the field.

### OBJECTS OF THE INVENTION

It is therefore an object of the present invention to provide an improved drill chuck.

Another object is the provision of such an improved drill chuck which overcomes the above-given disadvantages, that is which can easily be removed from and replaced on a drill spindle.

### SUMMARY OF THE INVENTION

A drill has according to the invention a drive spindle centered on and rotatable about a spindle axis and formed centered on the axis with an axially forwardly open socket of noncircular section and with at least one radially throughgoing passage open radially inward into the socket. A locking element is radially displaceable in the passage between an inner position projecting radially inward into the socket and an outer position clear of the socket and projecting radially outward from the spindle. A collar is formed with an inner surface closely juxtaposed with an outside surface of the spindle and with a radially inwardly open recess. The collar is axially displaceable on the spindle between a locked position with its inner surface pressing the element into the inner position and an unlocked position with its recess level with the element and the element movable into the outer position engaged in the collar recess.

Such a drill can be used, when the socket is of a standardized, by chucking the standard-shank tool directly in the spindle of the drill. For instance when a standard hexagonal section is used, standard hex-shank drill bits, driver bits, and the like can be chucked directly. Furthermore according to the invention it is possible to provide a standard three-jaw chuck with a hex stem that can be chucked in the spindle for use of the drill with smooth-shank bits and the like. The changeover can be executed simply in the field with no tools whatsoever.

According to the invention the collar recess has angled flanks engageable with the element. In addition a spring can be braced between the spindle and the collar urging the collar into the locked position.

In another system in accordance with the invention a knockout rod axially displaceable in the spindle is axially engageable into the socket. A spring urges the knockout rod outward into the socket. With this arrangement a second locking element can be radially engageable with the knockout rod and with the collar. The second locking element is movable out of engagement with the knockout rod on displacement of the collar into the unlocked position. The spindle is formed with a second radially extending passage level with the knockout rod and holding the second locking element and the knockout rod is in turn formed with a radially outwardly open recess in which the second element is radially engageable in the locked position of the collar. Thus pulling back the collar frees both the tool held in the socket and the knockout rod, so that the knockout rod moves forward and ejects the tool. Forcing a stem or shaft of a new tool back into the socket automatically resets the knockout rod and loads its spring.

It is possible in accordance with the invention for the spindle to have an outer part forming the socket and an inner part. The outer and inner parts are threaded together. Thus the outer part can in effect be an adapter that fits to an existing threaded-spindle drill, giving it the quick-change advantages of the instant invention.

According to the invention the spindle is formed with a plurality of the passages each receiving a respective one of the locking elements. The recess of the stem is a radially outwardly open groove. The elements can be balls for a very solid multipoint hold of the spindle on the tool inserted in its socket.

To center the tool held in the socket, it is formed with a rotation-symmetrical surface portion centered on the spindle axis. This surface can be formed in the socket or on the outside of the spindle. In addition to transmit axial force from the spindle to the tool in the socket, the spindle has a planar axially directed face lying in a plane perpendicular to the axis. This face is typically formed at an outer end of the spindle.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one figure but identical to those of another refer to structure that in functionally if not structurally identical. In the accompanying drawing:

FIGS. 1 and 2 are side views partly in axial section through a chuck according to the invention in mounted and unmounted condition;

FIGS. 3 and 4 are views like FIGS. 1 and 2 of a second chuck in accordance with the invention;

FIGS. 5 and 6 are views like FIG. 1 of third and fourth chucks according to the invention; and

FIGS. 7 and 8 are views like FIGS. 1 and 2 of a fifth chuck in accordance with the invention.

### SPECIFIC DESCRIPTION

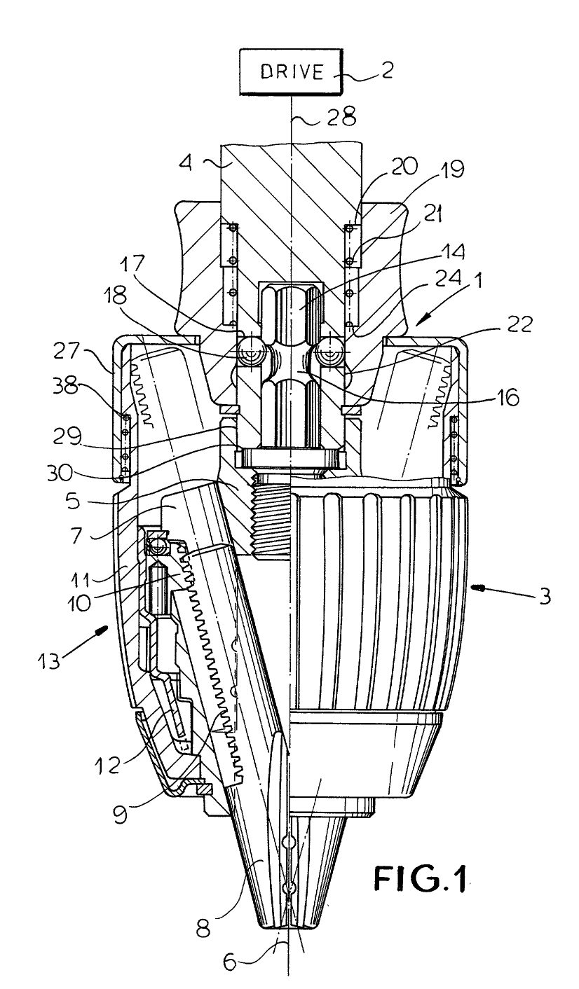

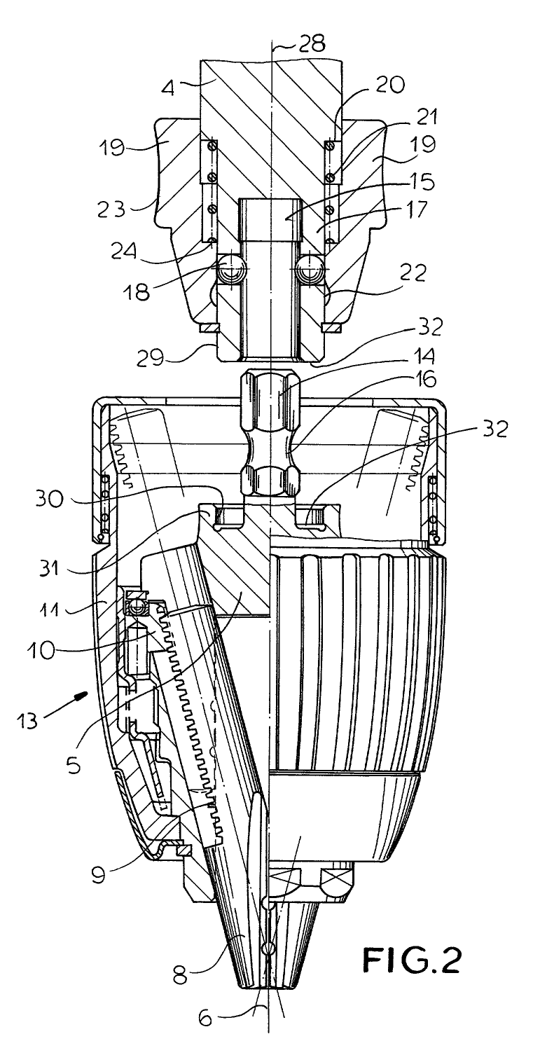

As seen in FIGS. 1 and 2 a drill 1 comprises a chuck 3 and a drive unit 2. The chuck 3 is mounted on a drill spindle 4 of the unit 2 for rotation about an axis 28 on which the spindle 4 is centered. The chuck 3 is centered on an axis 6 normally coaxial with the spindle axis 28 and has a body 5 formed with three angled guides 7 each holding a respective slidable jaw 8 having a toothed rear edge 9 meshing with an internal screwthread of a tightening ring 10. A tightening sleeve 11 is connected via a coupling sleeve 12 to the ring 10 and a locking mechanism 13 is provided for preventing unwanted rotation of the ring 10 relative to the body 5. Rotation of the sleeve 13 with the ring 10 in one direction about the axis 6 moves the jaws 8 axially forward (down in FIGS. 1 and 2) and together to grip a tool or workpiece and opposite rotation spreads them to dechuck the tool or workpiece. This is all generally standard and well known in the art.

In accordance with the invention the chuck body 5 has an axially centered and rearwardly projecting shaft or stem 14 which is at least partially of nonround, here hexagonal, section and that fits into an axially forwardly open blind bore or socket 15 of complementary shape and section formed at a front end of the spindle 4. Thus when the stem 14 is fitted to the socket 15, the body 5 is rotationally locked to the shaft 4.

The stem 14 is formed with a radially outwardly open recess or groove 16 into which can engage a plurality of locking elements or balls 18 received in respective radial passages 17 formed in the end of the spindle 4. The wall thickness of this end of the spindle 4 is smaller than the diameter of the balls 18 so that they must project either radially outward or inward from the respective passages 17 which therefore are shorter than the diameters of the balls 18.

The spindle 4 is surrounded by an axially slidable locking collar 19 formed with a radially inwardly open recess or groove 22 that can be moved into a position axially level with the balls 18, but otherwise a cylindrical inner surface of this collar 19 lies snugly against a cylindrical outer surface 29 of the end of the spindle 4 and normally forces the balls 18 to project radially inward from the inner surface of the bore 15. A spring 21 braced axially between a forwardly directed shoulder 20 of the spindle 4 and a rearwardly directed shoulder 24 of the collar 19 urges the collar 19 forward into a locked position with the groove 22 offset axially forward and the balls 18 projecting into the bore 15. A thin-wall sheet-metal sleeve 27 carried on the rear end of the chuck body 5 is also urged axially forward by a spring 38 and can bear axially rearward on the collar 19 which has an outside formation 23 adapted to be grasped by the fingers of the user of the tool.

Thus in the locked position of FIG. 1 the balls 18 engage in the groove 16 and fix the chuck 3 axially to the spindle 4. Pulling the collar 19 back, either directly or by pulling back the sleeve 27, into an unillustrated unlocked position allows the balls 1B to move radially outward and free the stem 14, which can then be pulled axially forward off the spindle 4 as shown in FIG. 2. To fit the chuck 3 back onto the spindle 4, the collar 19 is retracted to allow the balls 18 to move radially outward, the stem 14 is fitted back into the bore 15, and the collar 19 is released to fix it in place. The flanks of the groove 22 are angled at about 45° to the axis 28 so that they can cam the balls 18 inward and do not catch on them.

The chuck body 5 is formed with a rearwardly open annular seat having a cylindrical inner wall 30 that can fit snugly with the cylindrical outer wall 29 of the end of the spindle 4 and that is formed by a rearwardly projecting and axially centered collar 31 formed on the body 5. The spindle 4 and chuck body 5 have axially flatly engageable and planar annular surfaces 32 that allow substantial axial pressure to be transmitted from the chuck body 5 back to the spindle 4, while the interfitting surfaces 29 and 30 keep these two parts perfectly centered on each other and maintain the axes 6 and 28 coaxial.

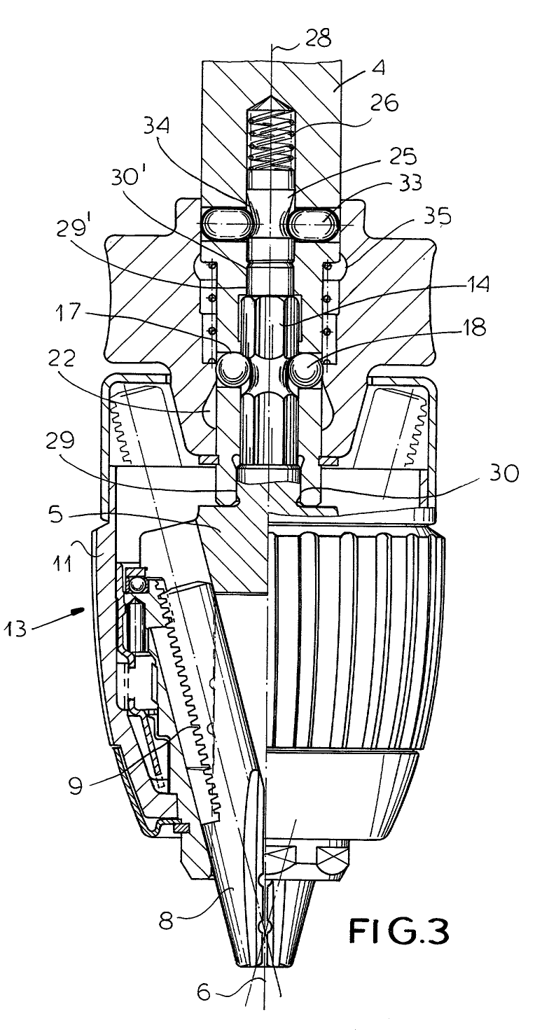

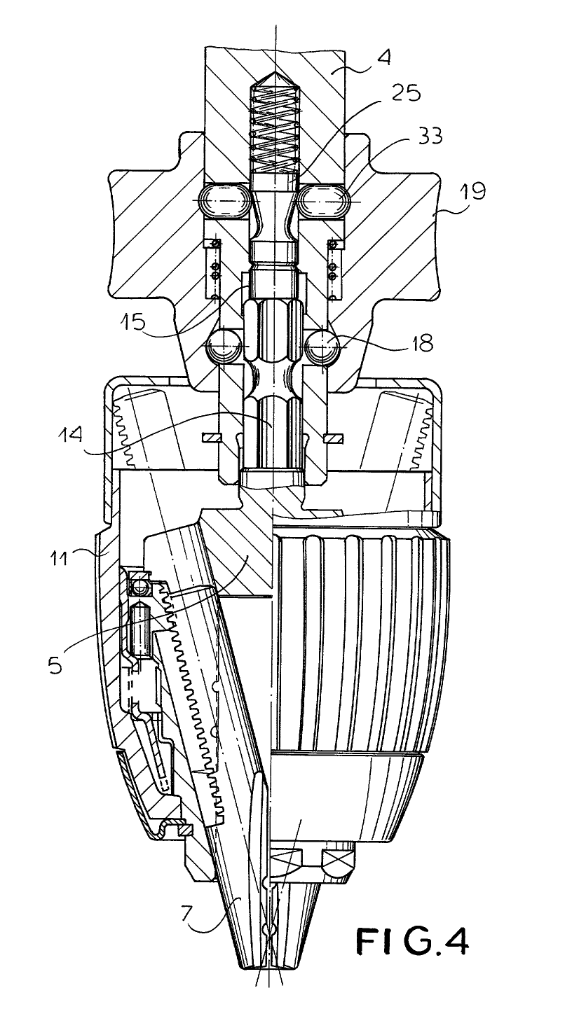

In the arrangement of FIGS. 3 and 4 the spindle 4 holds an axially displaceable knockout rod 25 urged axially forward by a spring 26 into engagement with the rear end of the stem 14 which here is shown having at its rearmost end a cylindrical surface 29′ slidable in a cylindrical surface 30′ at the rear end of the bore 15. A radially outwardly open recess or groove 34 on the knockout rod 25 can receive inner ends of radially displaceable locking elements 33 that can also engage, like the balls 18, in a radially inwardly open groove or recess 35 of the collar 19. Thus, when the collar 19 is in the front locking position shown in FIG. 3, the elements 18 and 33 are pressed radially inward to lock the stem 14 in place as described above and to lock the knockout rod 25 in a rear position. When the collar 19 is moved into the rear unlocking position shown in FIG. 4, the stem 14 is first freed by the balls 18 as described above and then the knockout rod 25 is similarly freed to press axially forward with the force of the spring 26 on the rear end of the stem 14, urging the chuck 3 off the spindle 4.

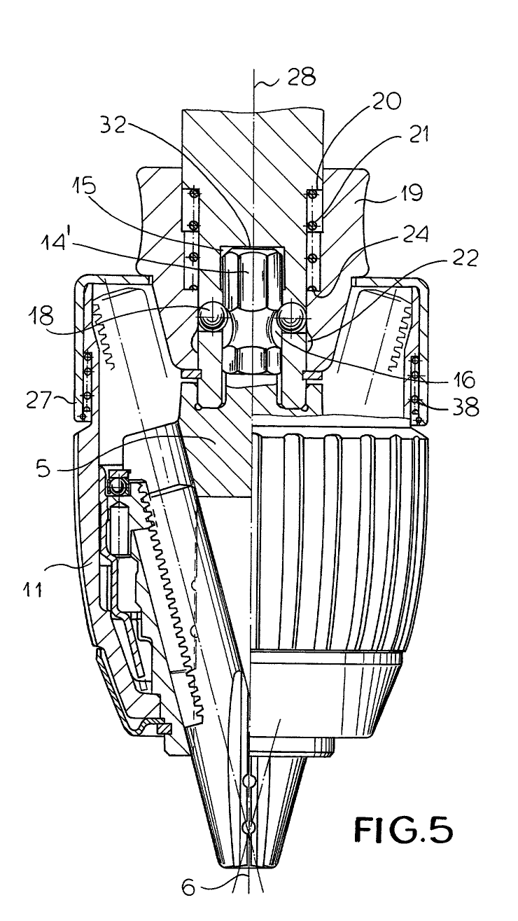

In FIG. 5 the stem 14′ is not unitary with the chuck body 5, but instead is a separate piece screwed centrally from the rear into the body 5. In addition the surfaces 32 are formed by the end of the stem 14 and the floor of the socket 15. Otherwise this system is identical to that of FIGS. 1 and 2.

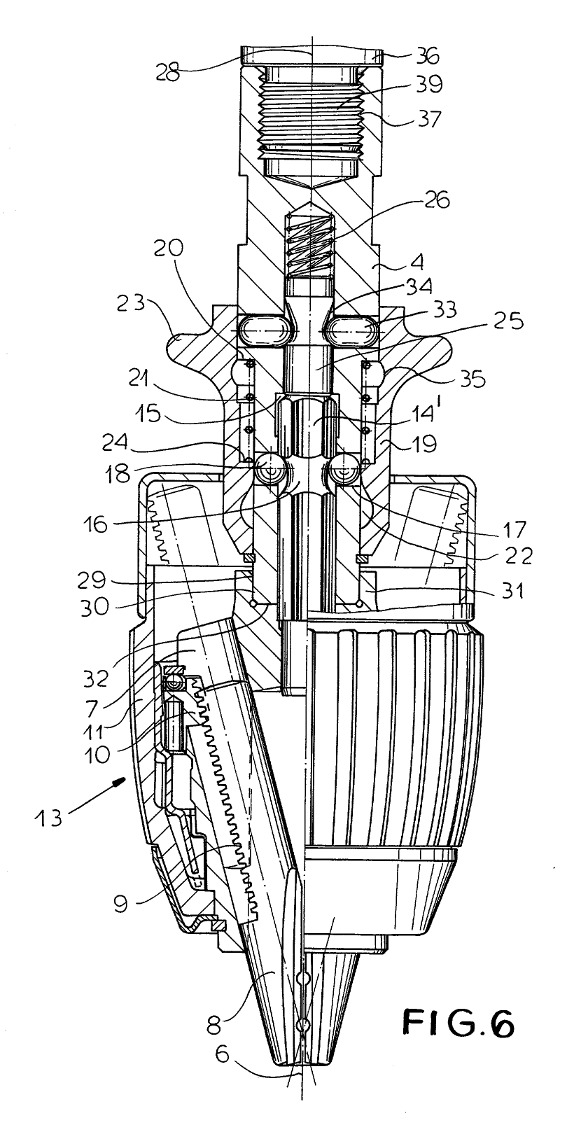

FIG. 6 shows an arrangement where the spindle 4 is formed with a rearwardly open seat 37 that is fitted to a threaded front end 39 of a drill spindle 36. Thus this system can be adapted to a standard threaded-spindle drill unit. Here also the finger formation 23 is formed as a radially outwardly projecting ridge, not as a radially outwardly open shallow groove as in FIGS. 1 through 5. The spindle part 4′ is also separate from joined to the stem 36 of the drive unit somewhat as in FIG. 5. Similarly the stem 14′ is integrally joined to but not unitary with the chuck body 5.

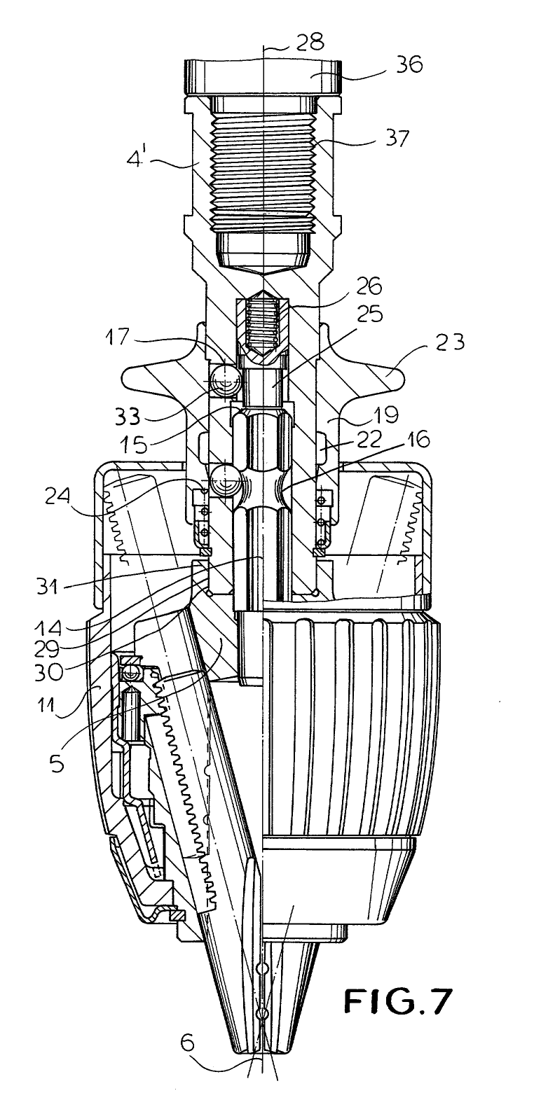

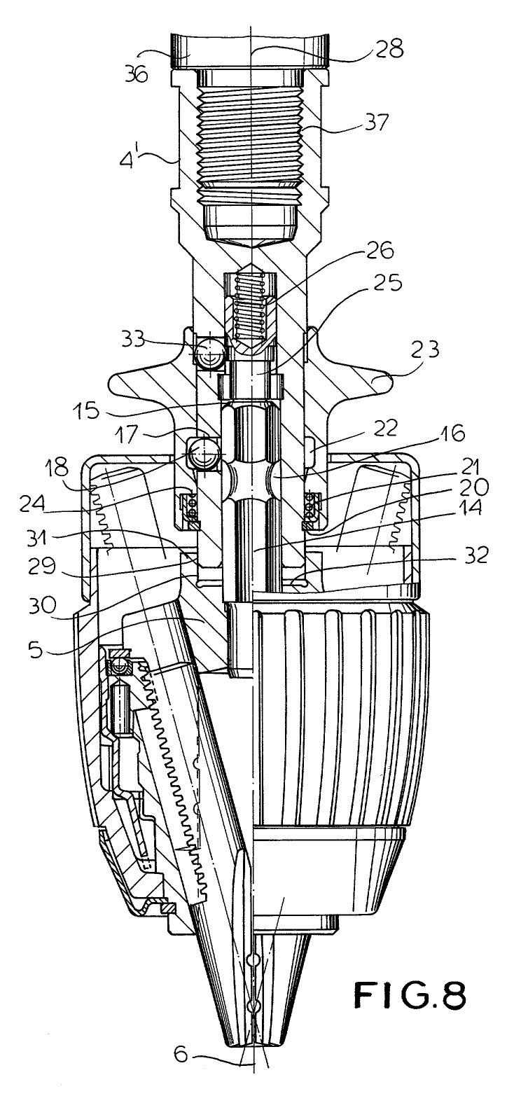

The system of FIGS. 7 and 8 is a hybrid of the systems of FIGS. 1 through 6, with a knockout rod 25 and a separate spindle part 4′.

I claim:

1. A drill comprising;
a drive spindle centered on and rotatable about a spindle axis and formed centered on the axis with an axially forwardly open socket of noncircular section and with at least one radially throughgoing passage open radially inward into the socket;
a locking element radially displaceable in the passage between an inner position projecting radially inward into the socket and an outer position clear of the socket and projecting radially outward from the spindle; and
a collar formed with an inner surface closely juxtaposed with an outside surface of the spindle and with a radially inwardly open recess, the collar being axially displaceable on the spindle between a locked position with its inner surface pressing the element into the inner position and an unlocked position with its recess level with the element and the element movable into the outer position engaged in the collar recess.

2. The drill defined in claim 1 wherein the collar recess has angled flanks engageable with the element.

3. The drill defined in claim 1, further comprising
a spring braced between the spindle and the collar urging the collar into the locked position.

4. The drill defined in claim 1, further comprising:
a knockout rod axially displaceable in the spindle and axially engageable into the socket; and
a spring urging the knockout rod outward into the socket.

5. The drill defined in claim 4, further comprising;
a second locking element radially engageable with the knockout rod and with the collar, the second locking element being movable out of engagement with the knockout rod on displacement of the collar into the unlocked position.

6. The drill defined in claim 5 wherein the spindle is formed with a second radially extending passage level with the knockout rod and holding the second locking element, the knockout rod being formed with a radially outwardly open recess in which the second element is radially engageable in the locked position of the collar.

7. The drill defined in claim 1 wherein the spindle has an outer part forming the socket and an inner part, the outer and inner parts being threaded together.

8. The drill defined in claim 1 wherein the spindle is formed with a plurality of the passages each receiving a respective one of the locking elements, the recess of the stem being a radially outwardly open groove.

9. The drill defined in claim 1 wherein the socket is of polygonal section.

10. The drill defined in claim 1 wherein the socket is formed with a rotation-symmetrical surface portion centered on the spindle axis.

11. The drill defined in claim 10 wherein the rotation-syrmmetrical surface portion is formed in the socket.

12. The drill defined in claim 10 wherein the rotation-symmetrical surface portions is formed on the outside of the spindle.

13. The drill defined in claim 1 wherein the spindle has a planar axially directed face lying in a plane perpendicular to the axis.

14. The drill defined in claimn 13 wherein the face is formed at an outer end of the spindle.
